(19) United States
(12) Patent Application Publication
(10) Pub. No.: US 2015/0120729 A1
(43) Pub. Date: Apr. 30, 2015

(54) WEB-BASED REPRESENTATIONAL STATE TRANSFER API SERVER

(71) Applicant: Nitro Mobile Solutions, LLC, Tampa, FL (US)

(72) Inventor: Peter C. Slade, Tampa, FL (US)

(21) Appl. No.: 14/515,580

(22) Filed: Oct. 16, 2014

Related U.S. Application Data
(60) Provisional application No. 61/895,502, filed on Oct. 25, 2013.

(51) Int. Cl. G06F 17/30; H04L 29/08

(52) U.S. Cl. CPC G06F 17/30864; H04L 67/02
USPC 707/736

(57) ABSTRACT

A middleware server solution that allows businesses to provide web based REST API's for use by mobile apps and websites. The server solutions includes a communications module for sending and receiving HTTP traffic, the communication module requiring the use of API keys and a data access module for selecting, inserting, deleting and updating data against a database store. A query store module maintains an array of REST services to respond to HTTP requests. The query store module further executes preprocessing JAVASCRIPT, executes SQL statements and executes post JAVASCRIPT. An automatic documentation module generates and distributes documentation to consumers of an API defined by a query store module configuration.

### BACKGROUND OF THE INVENTION

1. Field of the Invention

This invention relates to integration servers. More specifically, it relates to middleware server solution that allows businesses to provide web based representational state transfer (REST) application programming interfaces (APIs) for use by mobile apps and websites.

### BRIEF DESCRIPTION OF THE DRAWINGS

For a fuller understanding of the invention, reference should be made to the following detailed description, taken in connection with the accompanying drawings, in which:

FIG. 1 is a screen shot of an embodiment of the application graphic user interface showing the Query Store feature.

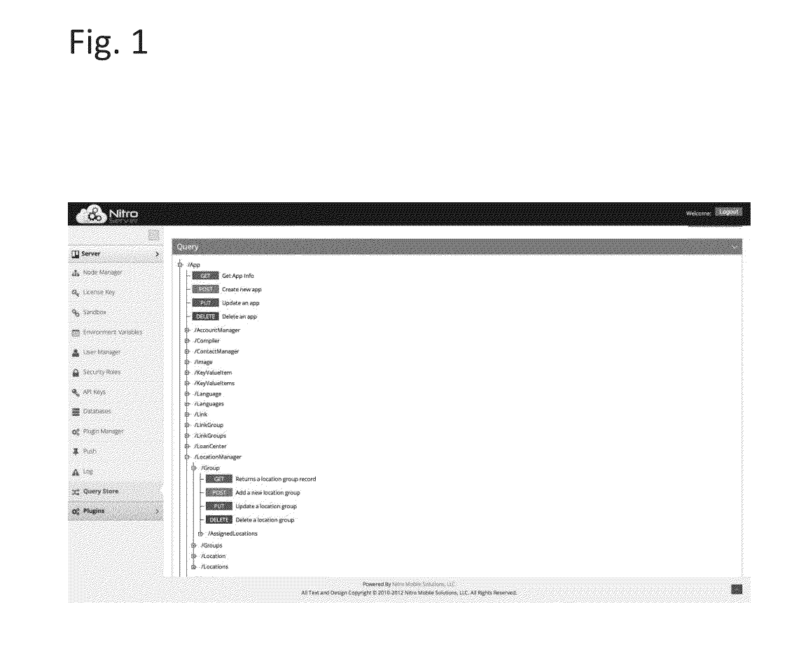

FIG. 2 is a screen shot of an embodiment of the application graphic user interface showing the Query Store feature with a mouse-over event result.

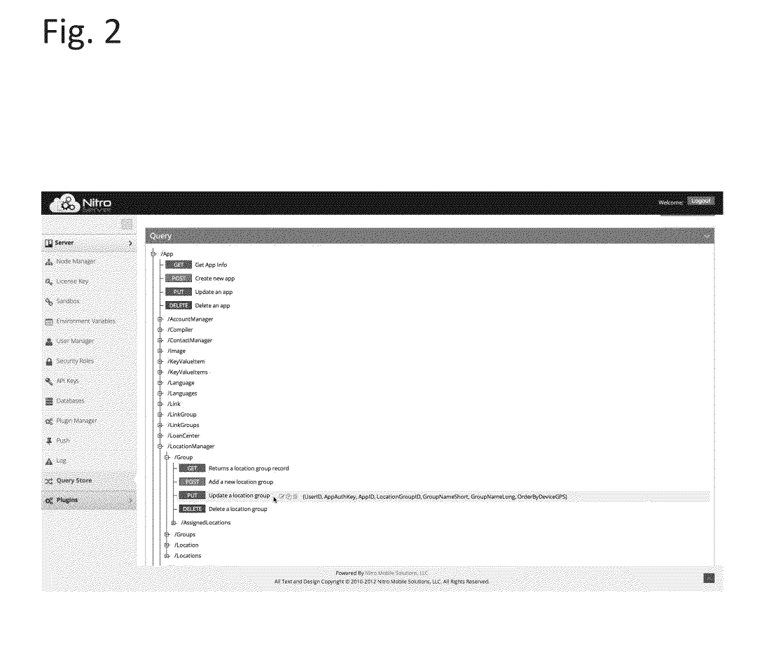

FIG. 3 is a screen shot of an embodiment of the application graphic user interface showing a configuration dialog interface for the Query Store.

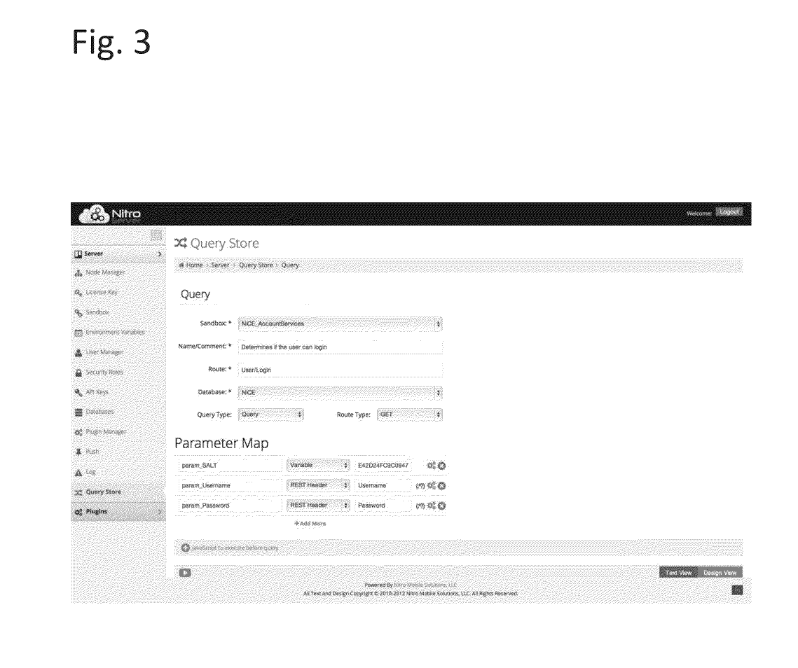

FIG. 4 is a screen shot of an embodiment of the application graphic user interface showing a SQL select query and JavaScript code to execute post-query.

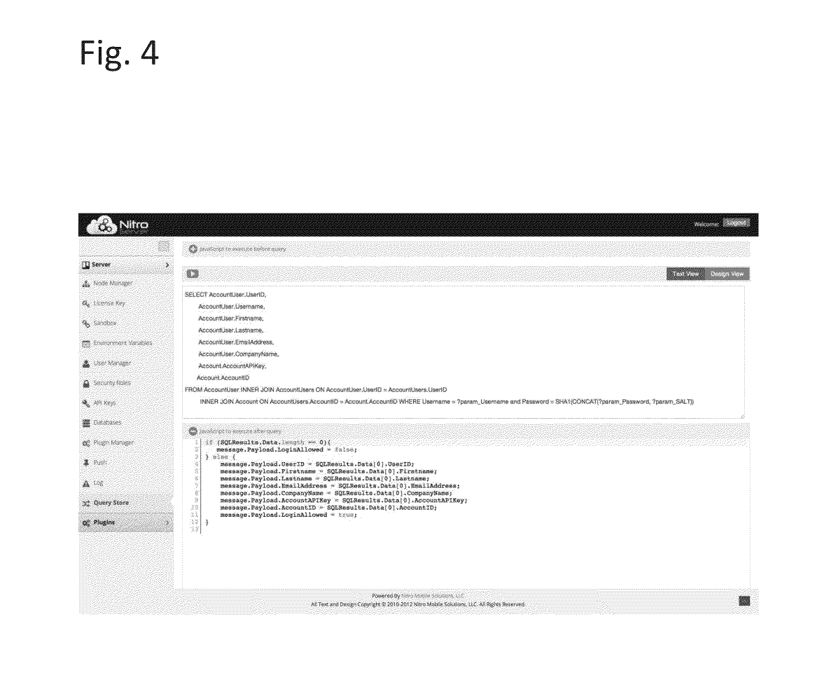

FIG. 5 is a screen shot of an embodiment of the application graphic user interface showing JSON output for documentation.

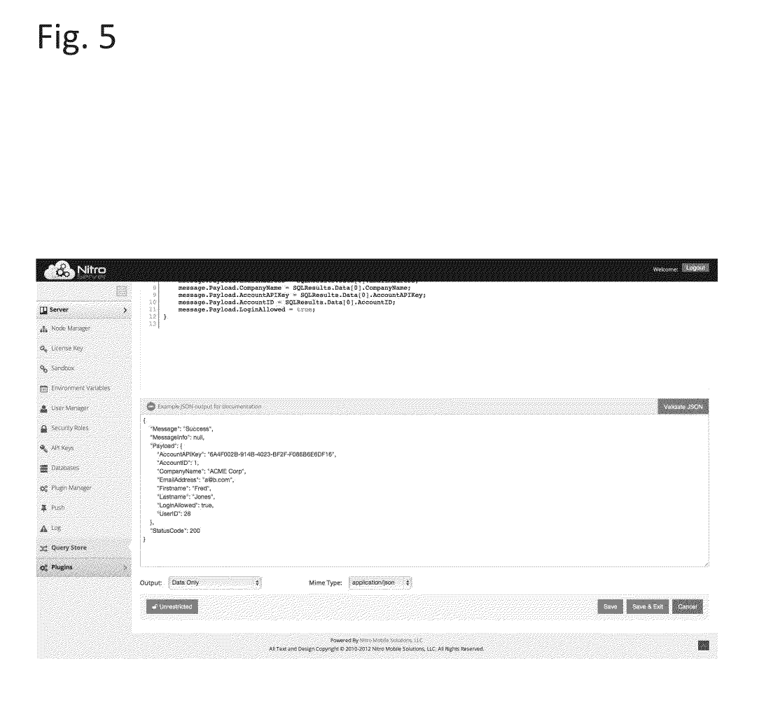

FIG. 6 is a screen shot of an embodiment of the application graphic user interface showing a modal dialog interface for query restrictions.

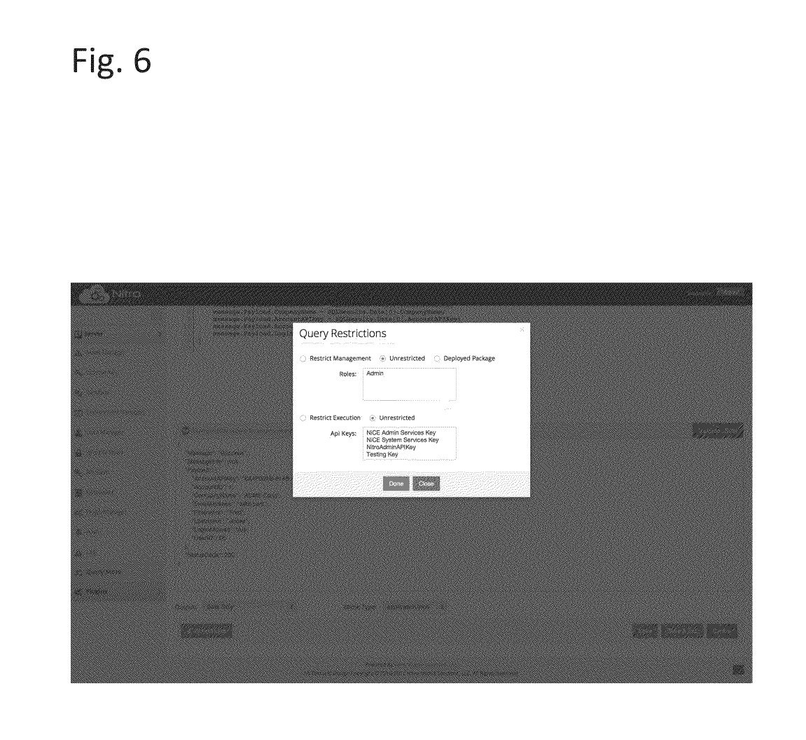

### DETAILED DESCRIPTION OF THE PREFERRED EMBODIMENT

The novel middleware server described herein is branded by the inventor as NITROSERVER. NITROSERVER uses a concept of scope (also known as sandbox) to create secure environments where plugins can be loaded into the server, but are only able to interact with other plugins and data that is also assigned or loaded into the same sandbox. This provides code isolation to protect plugins we create from other vendors or the customers own developers from being able to access each other. This also means we can jettison the plugins for a given sandbox and restart/reload them without needing to impact other plugins running on the server.

All communication requires the use of API keys (unless the sandbox explicitly sets that they are not needed). API Keys prevent unauthorized calls to the NITROSERVER API that do not specify an agreed key in their HTTP header.

NITROSERVER is built for clustering and uses a database for central configuration and operation. This allows unlimited numbers of peer NITROSERVERs to he setup to handle the load. Each NITROSERVER has a service which monitors the health of a NITROSERVER and provides performance information. This information is then used by various requests and scheduled tasks to determine the appropriate NITROSERVER node to perform the work.

For example, if there is a collection of high performance and a low performance machines running NITROSERVER and a job needs to run to summarize data, then the faster NITROSERVER will be selected to perform the work.

An embodiment of NITROSERVER includes a feature called QUERY STORE. This allows users to create their own REST services to respond to the GET, PUT, POST and DELETE HTTP requests. The web request is received by NITROSERVER and then QUERY STORE will map a URL route onto a configuration the user has created.

This configuration establishes a database connection, validates the e parameters being passed, executes any preprocessing lavaScript, executes the specified SQL statements, finally executes any post lavaScript to help format the DB response and returns to the data to the requestor. QUERY STORE allows developers to rapidly assemble and visualize web services they have created. It also creates automatic documentation that the users of QUERY STORE can distribute to consumers of their API.

### HARDWARE AND SOFTWARE INFRASTRUCTURE EXAMPLES

The present invention may be embodied on various computing platforms that perform actions responsive to software-based instructions. The following provides an antecedent basis for the information technology that may be utilized to enable the invention.

The computer readable medium described in the claims below may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire-line, optical fiber cable, radio frequency, etc., or any suitable combination of the foregoing. Computer program code for carrying out operations for aspects of the present invention may be written in any combination of one or more programming languages, including an object oriented programming language such as Java, C#, C++ or the like and conventional procedural programming languages, such as the “C” programming language or similar programming languages.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

### GLOSSARY OF CLAIM TERMS

Application programming interface (API) specifies how some software components should interact with each other.

Hypertext Transfer Protocol (HTTP) is an application protocol for distributed, collaborative, hypermedia information systems.

JavaScript (JS) is an interpreted computer programming language. As part of web browsers, implementations allow client-side scripts to interact with the user, control the browser, communicate asynchronously, and alter the document content that is displayed.

JavaScript Object Notation (JSON) is a text-based open standard designed for human-readable data interchange. Derived from the JavaScript scripting language, JSON is a language for representing simple data structures and associative arrays, called objects.

Structured Query Language (SQL) is a special-purpose programming language designed for managing data held in a relational database management system.

The advantages set forth above, and those made apparent from the foregoing description, are efficiently attained. Since certain changes may be made in the above construction without departing from the scope of the invention, it is intended that all matters contained in the foregoing description or shown in accompanying drawings shall be interpreted as illustrative and not in a limiting sense.

What is claimed is:

1. A computer-implemented server application, the application containing instructions stored on non-transitory computer media executable on at least one processor, the application comprising:
a communications module for sending and receiving HTTP traffic, the communication module requiring the use of API keys;
a data access module for selecting, inserting, deleting and updating data against a database store;
a query store module for maintain an array of REST services to respond to HTTP requests selected from the group consisting of GET, PUT, POST and DELETE, the query store module communicatively to the data access module and the communication module wherein the query store module further executes preprocessing JAVASCRIPT, executes SQL statements and executes post JAVASCRIPT; and
an automatic documentation module that generates and distributes documentation to consumers of an API defined by a query store module configuration.
